(19) United States
(12) Patent Application Publication
(10) Pub. No.: US 2016/0260071 A1
(43) Pub. Date: Sep. 8, 2016

(54) System and Method for Automating the Financing of a Business Sale

(71) Applicant: George Bechakas, Cheektowaga, NY (US)

(72) Inventor: George Bechakas, Cheektowaga, NY (US)

(21) Appl. No.: 14/640,054

(22) Filed: Mar. 6, 2015

(51) Int. Cl. G06Q 20/20; G06Q 40/06

(52) U.S. Cl. CPC G06Q 20/20; G06Q 40/06

(57) ABSTRACT

A system and method provides an easy financing option for a business buyer by enabling a business buyer to pay for a portion of the total purchase price of a business through revenue generated by the business. The business seller also is assured to receive the agreed upon sale price for the business, since the payment is automatically allocated for paying the total purchase price of the business as long as the business is operational and generating revenue. A point-of-sale system, such as a card payment reader, allocates a portion of the generated revenue from the business to an escrow system. The escrow system allocates an agreed upon portion of the revenue generated by the business to the business seller. The method may be especially effective for collecting debt for a business that was partially paid for, such as a financed business sale.

### FIELD OF THE INVENTION

The present invention relates generally to a system and method that automates the financing for the sale of a business. More so, a system and method facilitates the financing for the sale of a business by providing an automated, point-of-sale collection system that diverts a portion of revenue generated by the business towards paying off a balance owed for the business.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a business is an organization involved in the trade of goods and services. Businesses often have multiple employees, a management system, and an owner or stock holders. The business has a primary purpose of generating revenue to produce a profit. Businesses are prevalent in capitalist economies, where most of them are privately owned and provide goods and services to customers in exchange for other goods, services, or money. Businesses may also be not-for-profit or state-owned. A business owned by multiple individuals may be referred to as a company.

In many instances, business owners choose to sell their business for a variety of reasons. One common reason for selling a business relates to executive burn out. The constant pressure and concerns of the business tax even the most tenacious personality. Illness is another reason that compels some business owners to sell their business. It is not uncommon for a business owner who is experiencing health problems to decide to circumvent the long term effects of stress by selling their business. Other reasons also exist for selling a business. These may include more private issues such as a desire to cash out, divorce or even boredom with the day to day operations of the business. Still, other reasons relate to the business itself. Such examples may include business owners who sell because of a lack of working capital or because the business has grown beyond their management capabilities.

It is known in the art that business brokers are effective in assisting a business buyer and a business seller in the buying and selling process. The broker typically estimates the value of the business; advertises it for sale with or without disclosing its identity; handles the initial potential buyer interviews, discussions, and negotiations with prospective buyers; facilitates the progress of the due diligence investigation and generally assists with the business sale.

Often times, the business sale involves seller financing, which is where the seller of a business will finance a buyer of that business to buy his business. This type of financing, like other types of financing, can be quite sophisticated. There are foreclosure laws to protect the financier, but those legal mechanisms are expensive and complex to apply. With myriad small businesses transferring ownership each year seller financing would be well-received in the marketplace. However, the business buyer may not have sufficient funds to purchase the business, even with the seller financing. Furthermore, the business seller may not feel assured of receiving the periodic payments to pay off the agreed upon purchase price for the business.

Typically, credit cards and debit cards are a widely used financial instrument. Accordingly, in order to appeal to a broad base of potential buyers, it is advantageous for the business to be able to receive payment for goods or services utilizing a consumer's credit card. In order to receive credit card payments, the business is typically required to establish so-called merchant bank accounts with acquiring banks, into which a credit card fund transfer can credit funds received in payment of goods or services. Credit cards are generally a guaranteed source of revenue, as long as the business is operational and generating revenue.

Other proposals have involved purchasing businesses through owner financing and using credit cards for generating revenue. The problem with these systems and methods is that they do not enable a business buyer to pay a portion of the total purchase price for the business incrementally from a guaranteed source, or assure the business seller that payments will automatically be received as long as the business is operational.

Thus, an unaddressed need exists in the industry to address the aforementioned deficiencies and inadequacies. Even though the above cited methods for transacting a business sale meets some of the needs of the market, a system and method that helps finance the sale of a business from revenue generated from a point-of-sale system, such as a credit card reader, is still desired.

### SUMMARY OF THE INVENTION

The present invention is directed to a system and method that facilitates financing the sale of a business between a business buyer and a business seller by providing an automated, point-of-sale collection system that diverts a portion of revenue generated by the business towards paying off the balance of the total purchase price owed for the business.

In some embodiments, the system and method may provide an easy financing option for a business buyer that enables the business buyer to pay for a portion of the total purchase price of the business through revenue generated by the business; especially revenue from a point-of-sale system, such as a card payment reader. The business seller also is assured to receive the agreed upon sale price for the business, since the payment is automatically allocated for paying the total purchase price of the business as long as the business is operational. A point-of-sale system allocates a portion of the generated revenue from the business to an escrow system. The escrow system allocates an agreed upon portion of the revenue generated by the business to the business seller. The payments are made periodically and the total purchase price is paid within a predetermined period. The method may be especially effective for collecting debt for a business that was partially paid for, such as a financed business sale.

The system and method allows a business buyer to at least partially pay for the cost of a recently purchased business from a business seller through a point-of-sale system. The point-of-sale system transacts and diverts a portion of the generated revenue to an escrow system, which is accessible by the business seller. This, in essence, guarantees that the business seller receives the agreed upon total payment for the business as long as the business is operational and generating revenue. The point-of-sale system automates repayment for the financed business by diverting a portion of the revenues generated by the business from business revenue generated through a payment card. The payment card may include, without limitation, credit cards, debit cards, gift cards, PayPal™ payments, smartphone payments, and bank transfers.

In another embodiment, the point-of-sale system could also be expanded to transact and divert a portion of revenue generated through checks, wherein the business seller receives a portion, or all of the checks from the generated revenue. In either case, the portion of revenues diverted towards paying the balance owed on the business, or possibly the total cost of the business, is credited towards the agreed upon financed portion of the total cost for the business.

In some embodiments, all of the day to day credit card revenue generated by the business is automatically credited to the business seller through the escrow system. The system and method is especially effective in circumstances where the business buyer may not have sufficient funds to purchase the business at the requested cost; and thus, may pay a portion of the cost through revenue generated while operating the business. The business buyer is provided relief in not having to come up with the total price for the business, and is allowed to make incremental payments, in proportion to the business revenue.

Additionally, the business seller is at least partially guaranteed to receive the agreed upon total purchase price for the business as long as the business is operational. In essence, the method is like a security deposit system that ensures that the agreed upon price for purchasing a business is at least partially paid off automatically, even before the new business buyer receives revenue.

In some embodiments, the business seller may select to charge interest or no interest for the balance of the business. The business seller and/or the business buyer decides the proportion of revenues to allocate towards paying of the debt, and the type of point-of-sale system and financial instruments to use. This may depend largely on the type of business and how most revenue is generated. In yet another embodiment, the portion of the generated revenue allocated to the escrow system is variable, depending on the predetermined period for paying the total purchase price.

A first aspect of the present invention provides a method for automating the financing of a business sale, comprising:
determining, between a business buyer and a business seller, a total purchase price for a business;
determining a financed portion of the total purchase price;
paying, by the business buyer, at least a portion of the total purchase price for the business;
operating the business;
generating revenue, by the business, at least partially through a point-of-sale system;
automatically allocating, through an escrow system, at least a portion of the generated revenue from the point-of-sale system towards the financed portion of the total purchase price; and
receiving, by the business seller, the portion of the generated revenue from the escrow system.

In another aspect, the method comprises a central processor configured to control and monitor transactions.

In a second aspect of the financed portion of the total purchase price comprises a predetermined period for paying the total purchase price.

In another aspect, the point-of-sale system comprises a payment card reader.

In another aspect, the point-of-sale system is configured to operatively connect to the escrow system through a central processor.

In another aspect, the point-of-sale system is configured to receive revenue from a financial instrument, including, without limitation, credit cards, debit cards, gift cards, PayPal™ payments, smartphone payments, and bank transfers.

In another aspect, escrow system comprises an account where the portion of generated revenue accumulates and is accessible by the business seller.

In another aspect, the portion of the generated revenue allocated to the escrow system is variable, depending on the predetermined period for paying the total purchase price.

It is one objective of the present invention to automate the financing of a business sale through a point-of-sale system, such as a credit card reader that automatically allocates generated revenue to an escrow for paying off the total price of the business.

Yet another objective is to provide a guarantee to the business seller to receive the total payment in installments based on generated revenue of the business.

It is another objective to provide the business buyer an opportunity to purchase the business in installments, and based on the amount of revenue generated.

Yet another objective is to enable the business buyer to create a budget without being overwhelmed by paying off the total business cost if the generated revenue is low.

Yet another objective is to control the system and method with a central processor that may receive a fee for facilitating the transaction.

Yet another objective is to automatically divert generated revenue to the escrow system.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The present invention and the manner in which it may be practiced is further illustrated with reference to the accompanying drawings wherein:

FIG. 1 is a flowchart diagram of an exemplary method for automating the finance of a business sale, in accordance with an embodiment of the present invention;

FIG. 2 is a block diagram of an exemplary system for automating the finance of a business sale, in accordance with an embodiment of the present invention; and

FIG. 3 is a block diagram depicting an exemplary client/server system used by an exemplary web-enabled/networked, in accordance with an embodiment of the present invention.

Like reference numerals refer to like parts throughout the various views of the drawings.

### DETAILED DESCRIPTION OF THE INVENTION

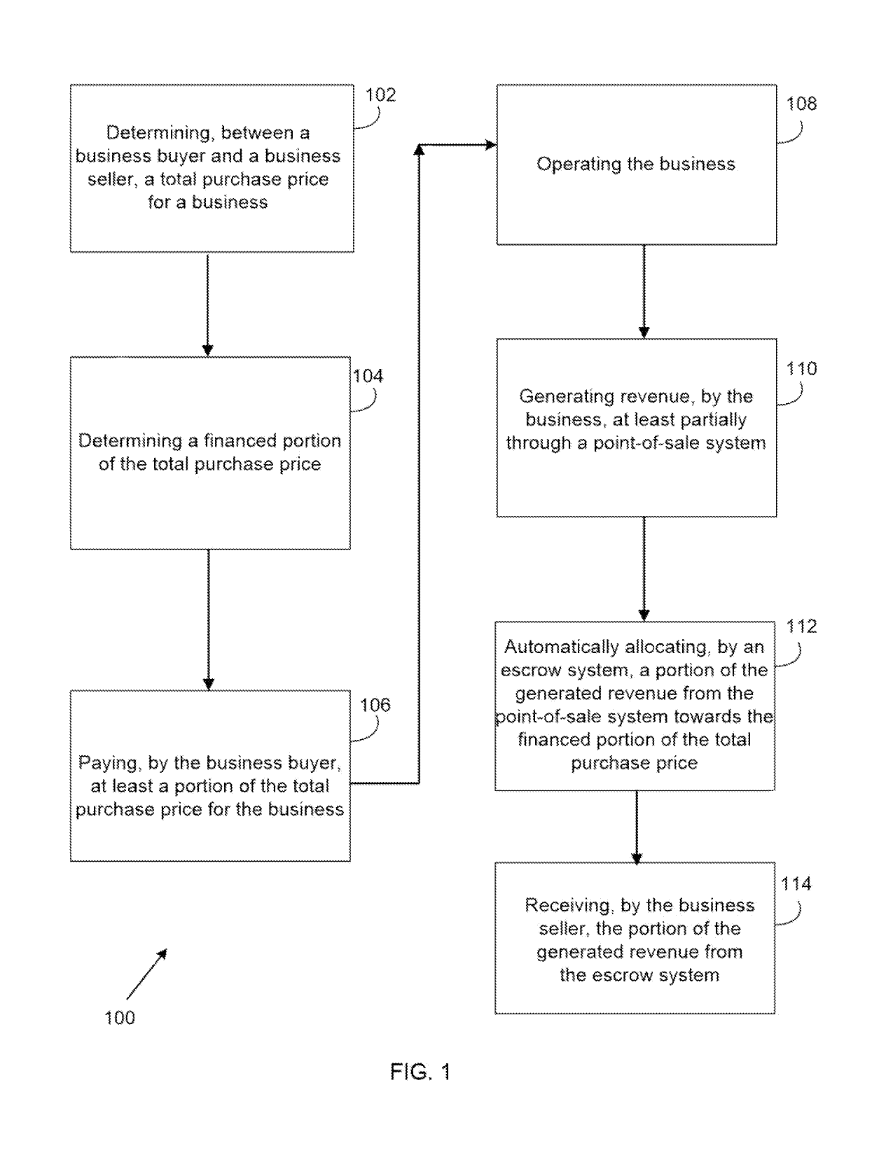

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention, presented in FIGS. 1-3, a method 100 and system 200 for automating the finance of a business sale is effective for financing the sale of a business 206 by providing an automated, point-of-sale system 212 that transacts generated revenue 214 from the business 206 and diverts a portion of revenue 214 towards paying off the balance of a total purchase price 208 owed for the business 206.

FIG. 1 illustrates a flowchart diagram of an exemplary method 100 for automating the finance of a business sale. In some embodiments, the method 100 may provide an easy financing option for a business buyer 202 to purchase a business 206. The method 100 also insures that a business seller 204 will be paid the agreed upon total purchase price 208 for the business 206, as long as the business 206 is operational and generating revenue 214. A point-of-sale system 212 transacts and diverts the generated revenue 214 to an escrow system 216. A central processor 220 controls the interconnections between the point-of-sale system 212 and escrow system 216, and also calculates the financed portion and generated revenue 214 to determine payment structure. The escrow system 216 periodically disburses the revenue to the business seller 204 within a predetermined period 218.

In some embodiments, the method 100 may provide an easy financing option for a business buyer 202 by enabling the business buyer 202 to pay for a portion of the total purchase price 208 of the business 206 through revenue 214 that is generated during operation of the business 206. This may negate the need to use a bank, and consequently incur heavy interest fees for a bank loan. However, in some embodiments, the method 100 may still add interest and fees to the total purchase price 208 of the business 206.

The business seller 204 is also assured to receive the agreed upon total purchase price 208 for the business 206, since the payments are automatically allocated by the escrow system 216, as long as the business 206 is operational and generating revenue 214. It is significant to note that the business buyer 202 may still be required to pay an initial payment for the business 206 before the business sale commences.

The point-of-sale system 212, including a payment card reader, may be efficacious for transacting and allocating a portion of the generated revenue 214 towards the escrow system 216 for the periodic payment of the total purchase price 208. The escrow system 216 enables the business seller 204 to have access to the agreed upon portion of the revenue 214 generated by the business 206. In some embodiments, the payments from the escrow system 216 to the business seller 204 are made periodically and within a predetermined period 218. The method 100 may be especially effective for collecting debt for a business 206 that was partially paid for, such as a financed business sale. The method 100 is also effective for helping a business buyer 202 purchase the business 206 with a small initial payment.

In some embodiments, the method 100 may include an initial Step 102 of determining, between a business buyer 202 and a business seller 204, a total purchase price 208 for a business 206. The agreed upon total purchase price 208 represents the initial payment portion, plus the subsequently owed financed portion 210 of the total purchase price 208. The total purchase price 208 may also include additional fees and interest, as agreed upon by the business buyer 202 and the business seller 204. In some embodiments, a business broker may be used to assist in the transaction. In some embodiments, the business seller 204 may relinquish all rights and operational concerns to the business buyer 202, either upon complete payment of the total purchase price 208, or while the financed portion 210 of the total purchase price 208 are being made. The business 206 may include, without limitation, a service business, a product supply business, an organization, a nonprofit group, and a future project.

The method 100 may further comprise a Step 104 of determining a financed portion 210 of the total purchase price 208. The financed portion 210 is agreed upon by the business buyer 202 and the business seller 204. In one embodiment, the financed portion 210 is greater than the initial payment portion. The financed portion 210 may be made periodically, and within a predetermined period 218. For example, without limitation, the business buyer 202 may be given three years to pay off the financed portion 210, with the generated revenue 214 providing a majority of this amount. However, the business buyer 202 may be required to add additional funds to the payments if the generated revenue 214 is insufficient.

A Step 106 includes paying, by the business buyer 202, at least a portion of the total purchase price 208 for the business 206. The portion may include an initial payment. The portion may also include fees, interest, and shares in the business. In some embodiments, the initial payment may be greater than the financed portion 210. In another embodiments, the financed portion 210 is greater. However, in any case, the financed portion 210 is paid substantially by the generated revenue 214.

In some embodiments, a Step 108 comprises operating the business 206. In order to generate revenue 214, the business 206 must be operational. In some embodiments, the business buyer 202 has complete control of the business 206 until the total purchase price 208 is paid. In another embodiment, the business buyer 202 retains partial control of the business 206 until the total purchase price 208 is paid.

A Step 110 includes generating revenue 214, by the business 206, at least partially through a point-of-sale system 212. The business 206 generates revenue 214 through operation. Payments to the business 206, generally by consumers and other businesses, may be transacted through electrical means, which is operable by the point-of-sale system 212. The point-of-sale system 212 may include a card reader that accepts a payment card. The payment card may include, without limitation, credit cards, debit cards, gift cards, PayPal™ payments, smartphone payments, and bank transfers.

Those skilled in the art will recognize that the substantially electronic process of generating revenue helps automate the dispersion of revenue for paying the financed portion 210 of the total purchase price 210. However, in one alternative embodiment, the system 200 could also be expanded to include revenue generated through checks, wherein the business seller 204 receives a portion, or all of the checks from the generated revenue 214. A central processor 220 controls the point-of-sale system 212 and monitors the payments. The central processor 220 may include an algorithm for allocating the revenue as agreed upon by the business buyer 202 and the business seller 204.

In some embodiments, a Step 112 may include automatically allocating, by an escrow system 216, at least a portion of the generated revenue 214 from the point-of-sale system 212 towards the financed portion 210 of the total purchase price 208. The escrow system 216 is operatively connected to the point-of-sale system 212. In this manner, a predetermined portion of the generated revenue 214 is automatically allocated and diverted to the escrow system 216 for subsequent access by the business seller 204. It is this automated allocation of revenue 214 that insures the business seller 204 to receive the total purchase price 208 as long as the business 206 is operational. In one alternative embodiment, the revenue 214 allocated to the escrow system 216 is variable. The variable amount of revenue 214 allocated to the escrow system 216 is dependent on the balance left for paying off the total purchase price 208, and also dependent on the length of the predetermined period 218 for paying off the total purchase price 208.

A final Step 114 comprises receiving, by the business seller 204, the portion of the generated revenue 214 received by the escrow system 216. The business seller 204 may receive the financed portion 210 periodically and within a predetermined period 218 from the escrow system 216. In another embodiment, the business seller 204 may access the escrow system 216 like a bank account. In yet another embodiment, the business seller 204 may add interest and fees to the financed portion 210, such that the escrow system receives and disperses the additional interest and fees to the business seller 204.

In some embodiments, the business seller 204 may charge interest, or no interest in addition to the total purchase price 208. The business seller 204 and/or the business buyer 202 decides the proportion of revenue 214 to allocate towards paying of the total purchase price 208, and the type of point-of-sale system 212 and other financial instruments to use. This decisions may depend largely on the type of business 206 and how most revenue 214 is generated.

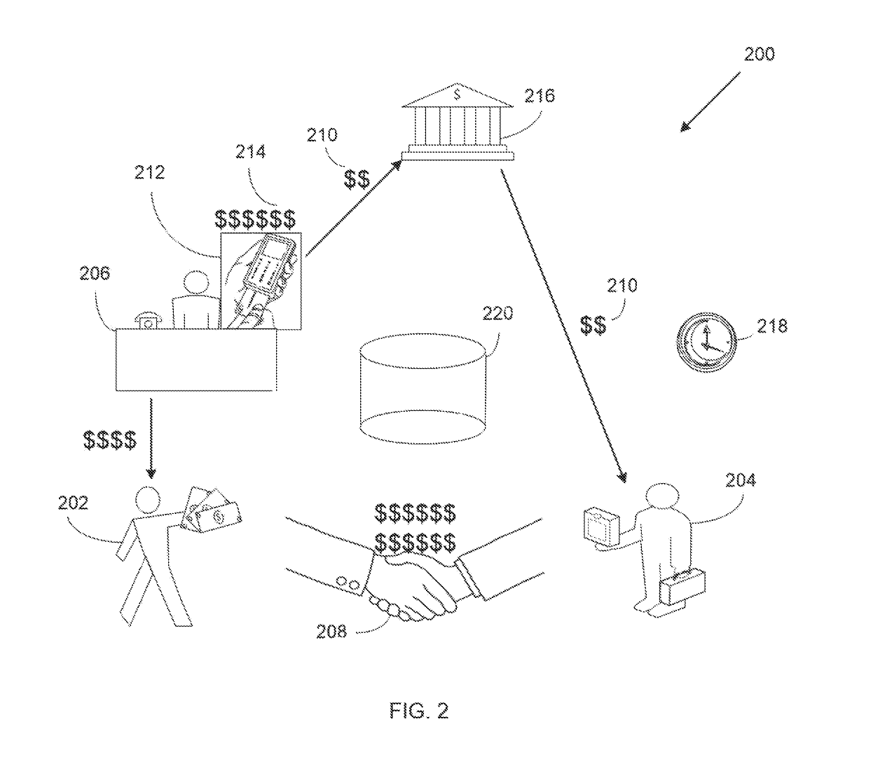

Turning now to FIG. 2, a system 200 for automating the finance of a business sale is effective for financing the sale of a business 206 through revenue 214 generated by an automated, point-of-sale system 212. The point-of-sale system 212 serves to divert a portion of the revenue 214 generated by the business 206 towards paying off the balance of the total purchase price 208 owed for the business 206. In this manner, the system 200 allows a business buyer 202 to at least partially pay for the cost of a recently purchased business 206 from a business seller 204 through a point-of-sale system 212. The point-of-sale system 212 transacts and diverts a portion of the generated revenue 214 to an escrow system 216, which is accessible by the business seller 204.

This, in essence, guarantees that the business seller 204 receives the agreed upon total purchase price 208 for the business 206 as long as the business 206 is operational and generating revenue 214. The point-of-sale system 212 automates repayment for the financed business 206 by diverting a portion of the revenues 214 generated by the business 206 to the escrow system 216. In one embodiment, the point-of-sale system 212 transacts the generated revenue 214 through a payment card. The payment card may include, without limitation, credit cards, debit cards, gift cards, PayPal™ payments, smartphone payments, and bank transfers.

In some embodiments, all of the day to day payment card revenue 214 is automatically credited to the business seller 204 through the escrow system 216. The system 200 is especially effective in circumstances where the business buyer 202 may not have sufficient funds to purchase the business 206 at the requested cost; and thus, may pay a portion of the cost through revenue 214 generated while operating the business 206. Furthermore, the business buyer 202 is provided relief in not having to come up with the total purchase price 208 for the business 206, and is allowed to make incremental payments, in proportion to the generated revenue 214. Additionally, the business seller 204 is at least partially guaranteed to receive the agreed upon total purchase price 208 for the business 206 as long as the business 206 is operational.

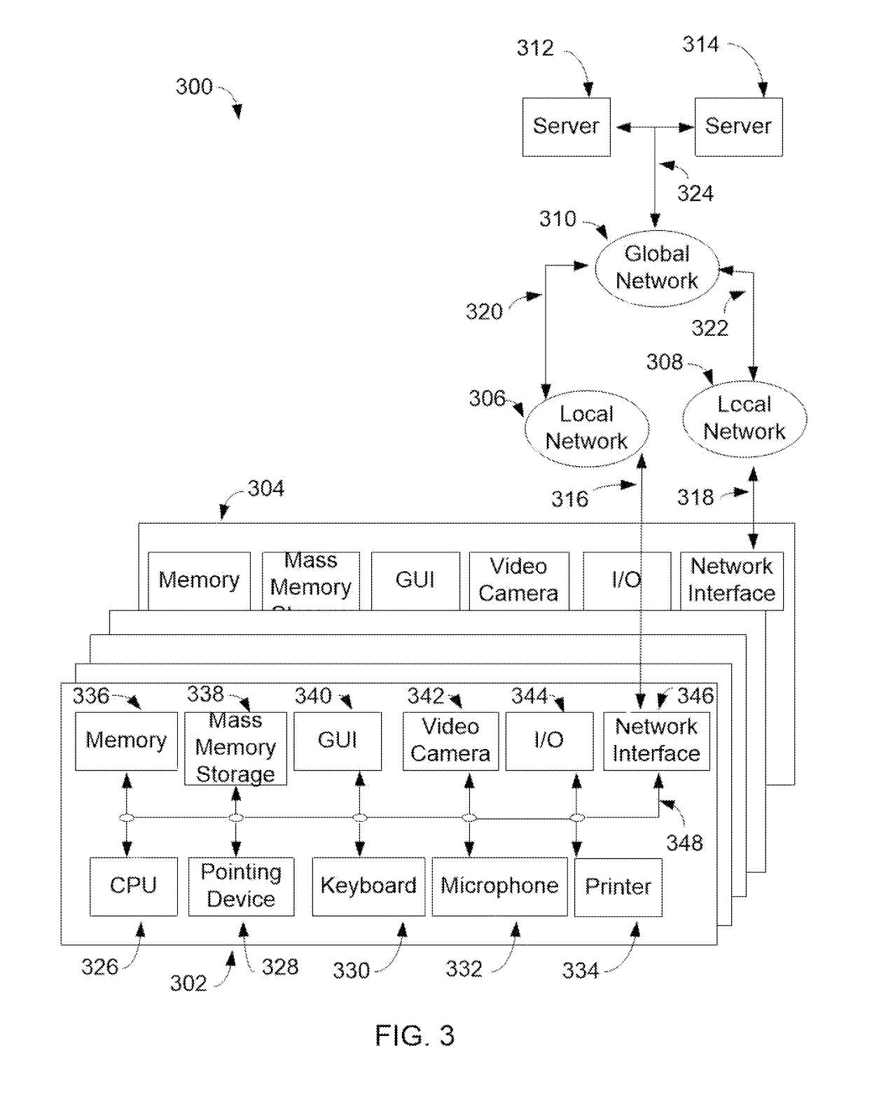

FIG. 3 is a block diagram depicting an exemplary client/server system which may be used by an exemplary web-enabled/networked embodiment of the present invention.

A communication system 300 includes a multiplicity of clients with a sampling of clients denoted as a client 302 and a client 304, a multiplicity of local networks with a sampling of networks denoted as a local network 306 and a local network 308, a global network 310 and a multiplicity of servers with a sampling of servers denoted as a server 312 and a server 314.

Client 302 may communicate bi-directionally with local network 306 via a communication channel 316. Client 304 may communicate bi-directionally with local network 308 via a communication channel 318. Local network 306 may communicate bi-directionally with global network 310 via a communication channel 320. Local network 308 may communicate bi-directionally with global network 310 via a communication channel 322. Global network 310 may communicate bi-directionally with server 312 and server 314 via a communication channel 324. Server 312 and server 314 may communicate bi-directionally with each other via communication channel 324. Furthermore, clients 302, 304, local networks 306, 308, global network 310 and servers 312, 314 may each communicate bi-directionally with each other.

In one embodiment, global network 310 may operate as the Internet. It will be understood by those skilled in the art that communication system 300 may take many different forms. Non-limiting examples of forms for communication system 300 include local area networks (LANs), wide area networks (WANs), wired telephone networks, wireless networks, or any other network supporting data communication between respective entities.

Clients 302 and 304 may take many different forms. Non-limiting examples of clients 302 and 304 include personal computers, personal digital assistants (PDAs), cellular phones and smartphones.

Client 302 includes a CPU 326, a pointing device 328, a keyboard 330, a microphone 332, a printer 334, a memory 336, a mass memory storage 338, a GUI 340, a video camera 342, an input/output interface 344 and a network interface 346.

CPU 326, pointing device 328, keyboard 330, microphone 332, printer 334, memory 336, mass memory storage 338, GUI 340, video camera 342, input/output interface 344 and network interface 346 may communicate in a unidirectional manner or a bi-directional manner with each other via a communication channel 348. Communication channel 348 may be configured as a single communication channel or a multiplicity of communication channels.

CPU 326 may be comprised of a single processor or multiple processors. CPU 326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 336 is used typically to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 338 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 may be coupled to GUI 340. GUI 340 enables a user to view the operation of computer operating system and software. CPU 326 may be coupled to pointing device 328. Non-limiting examples of pointing device 328 include computer mouse, trackball and touchpad. Pointing device 328 enables a user with the capability to maneuver a computer cursor about the viewing area of GUI 340 and select areas or features in the viewing area of GUI 340. CPU 326 may be coupled to keyboard 330. Keyboard 330 enables a user with the capability to input alphanumeric textual information to CPU 326. CPU 326 may be coupled to microphone 332. Microphone 332 enables audio produced by a user to be recorded, processed and communicated by CPU 326. CPU 326 may be connected to printer 334. Printer 334 enables a user with the capability to print information to a sheet of paper. CPU 326 may be connected to video camera 342. Video camera 342 enables video produced or captured by user to be recorded, processed and communicated by CPU 326.

CPU 326 may also be coupled to input/output interface 344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 326 might receive information from the network, or might output information to a network in the course of performing the method steps described in the teachings of the present invention.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A method for automating the financing of a business sale, the method comprising:
determining, between a business buyer and a business seller, a total purchase price for a business;
determining a financed portion of the total purchase price;
paying, by the business buyer, at least a portion of the total purchase price for the business;
operating the business;
generating revenue, by the business, at least partially through a point-of-sale system;
automatically allocating, through an escrow system, at least a portion of the generated revenue from the point-of-sale system towards the financed portion of the total purchase price; and
receiving, by the business seller, the portion of the generated revenue from the escrow system.

2. The method of claim 1, wherein the escrow system comprises an account where the portion of generated revenue accumulates and is accessible by the business seller.

3. The method of claim 1, wherein the financed portion of the total purchase price comprises a predetermined period for paying the total purchase price.

4. The method of claim 1, wherein the financed portion is greater than the initial payment of the total purchase price.

5. The method of claim 1, wherein the generated revenue allocated to the escrow system is variable, depending on the predetermined period for paying the total purchase price.

6. The method of claim 1, wherein the business includes at least one member selected from the group consisting of: a service business, a product supply business, an organization, and a nonprofit organization.

7. The method of claim 1, wherein the method comprises a central processor configured to control and monitor payments.

8. The method of claim 7, wherein the central processor comprises an algorithm, the algorithm configured to calculate the financed portion and regulate the portion of revenue allocated to the escrow system.

9. The method of claim 8, wherein the point-of-sale system is configured to operatively connect to the escrow system through the central processor.

10. The method of claim 1, wherein the point-of-sale system comprises a credit card reader.

11. The method of claim 1, wherein the point-of-sale system is configured to receive revenue from a financial instrument, including at least one member selected from the group consisting of: credit cards, debit cards, gift cards, PayPal™ payments, smartphone payments, and bank transfers.

12. A method for automating the financing of a business sale, the method comprising:
determining, between a business buyer and a business seller, a total purchase price for a business;
determining a financed portion of the total purchase price;
paying, by the business buyer, at least a portion of the total purchase price for the business as an initial payment, wherein the initial payment is generally smaller than the financed portion;
operating the business;
generating revenue, by the business, at least partially through a credit card reader;
automatically allocating, through an escrow system, at least a portion of the generated revenue from the credit card reader towards the financed portion of the total purchase price;
controlling the escrow system and the credit card reader though a central processor; and
receiving, by the business seller, the portion of the generated revenue from the escrow system, wherein the business seller receives the portion of the generated revenue periodically and within a predetermined period.

13. The method of claim 12, wherein the escrow system comprises an account where the portion of generated revenue accumulates and is accessible by the business seller.

14. The method of claim 12, wherein the generated revenue allocated to the escrow system is variable, depending on the predetermined period for paying the total purchase price.

15. The method of claim 12, wherein the business includes at least one member selected from the group consisting of: a service business, a product supply business, an organization, and a nonprofit organization.

16. The method of claim 12, wherein the point-of-sale system is configured to receive revenue from a financial instrument, including at least one member selected from the group consisting of: credit cards, debit cards, gift cards, PayPal™ payments, smartphone payments, and bank transfers.

17. One or more computer storage media storing computer-usable instructions, that when used by one or more computing devices, cause the one or more computing devices to perform a method comprising the steps of:
paying a fee to access said method;
determining, between a business buyer and a business seller, a total purchase price for a business;
determining a financed portion of the total purchase price;
paying, by the business buyer, at least a portion of the total purchase price for the business;
operating the business;
generating revenue, by the business, at least partially through a point-of-sale system;
automatically allocating, through an escrow system, at least a portion of the generated revenue from the point-of-sale system towards the financed portion of the total purchase price; and
receiving, by the business seller, the portion of the generated revenue from the escrow system.

18. The method of claim 17, wherein the business includes at least one member selected from the group consisting of: a service business, a product supply business, an organization, and a nonprofit organization.

19. The method of claim 17, wherein the method comprises a central processor configured to control and monitor payments.

20. The method of claim 17, wherein the central processor comprises an algorithm, the algorithm configured to calculate the financed portion and regulate the portion of revenue allocated to the escrow system.
